(19) United States
(12) Patent Application Publication
(10) Pub. No.: US 2005/0071596 A1
(43) Pub. Date: Mar. 31, 2005

(54) Method, apparatus and program storage device for providing automatic performance optimization of virtualized storage allocation within a network of storage elements

(75) Inventors: John George Aschoff, Watsonville, CA (US); Neena A. Cherian, San Jose, CA (US); Brian Jay Smith, San Francisco, CA (US)

Correspondence Address: Crawford Maunu PLLC, Suite 390, 1270 Northland Drive, St. Paul, MN, 55120, US

(73) Assignee: International Business Machines Corporation

(21) Appl. No.: 10/672,423

(22) Filed: Sep. 26, 2003

(51) Int. Cl. G06F 12/00

(52) U.S. Cl. 711/170

(57) ABSTRACT

A method, apparatus and program storage device for providing automatic performance optimization of virtualized storage allocation within a network of storage elements is disclosed. A request for storage of data is received and workload requirements of the user making the request are obtained. System parameters are analyzed and storage is provided to meet the desired performance requirements based on analysis of system parameters.

### BACKGROUND OF THE INVENTION

1. Field of the Invention

This invention relates in general to network storage systems, and more particularly to a method, apparatus and program storage device for providing automatic performance optimization of virtualized storage allocation within a network of storage elements.

2. Description of Related Art

In enterprise data processing arrangements, such as may be used in a company, government agency or other entity, information is often stored on servers and accessed by users over, for example, a network. The information may comprise any type of information that of programs and/or data to be processed. Users, using their personal computers, workstations, or the like (generally, “computers”) will enable their computers to retrieve information to be processed, and, in addition, to store information, for example, on remote servers.

Generally, servers store data in mass storage subsystems that typically include a number of disk storage units. Data is stored in units, such as files. In a server, a file may be stored on one disk storage unit, or alternatively portions of a file may be stored on several disk storage units. A server may service access requests from a number of users concurrently, and it will be appreciated that it will be preferable that concurrently serviced access operations be in connection with information that is distributed across multiple disk storage units, so that they can be serviced concurrently. Otherwise stated, it is generally desirable to store information in disk storage units in such a manner that one disk drive unit not be heavily loaded, or busy servicing accesses, and while others are lightly loaded or idle.

A computer network of a business may have multiple storage networks that are located remote from one another and a business user. The storage networks may also be hosted on different types of systems. To perform the job correctly,the business user may require fast and reliable access to the data contained in all of the storage networks. Information Technology (IT) employees must be able to provide high-speed, reliable access to the business users.

Storage area networks (SANs) are high-speed, high-bandwidth storage networks that logically connect the data storage devices to servers. The business user, in turn, is typically connected to the data storage devices through the server. SANs extend the concepts offered by traditional server/storage connections and deliver more flexibility, availability, integrated management and performance. SANs are the first IT solutions to allow users access to any information in the enterprise at any time. Generally the SAN includes management software for defining network devices such as hosts, interconnection devices, storage devices, and network attach server (NAS) devices. The SAN management software also allows links to be defined between the devices.

One important component in reaching this goal is to allow the SAN to be fully understood by those designing and maintaining the SAN. It is often difficult to quickly understand the SAN due to its complexity. Tools that allow the configuration of the SAN to be understood and changed quickly are beneficial.

One of the advantages of a SAN is the elimination of the bottleneck that may occur at a server, which manages storage access for a number of clients. By allowing shared access to storage, a SAN may provide for lower data access latencies and improved performance. However, in a large storage network such as SAN attached storage, it is difficult for a storage administrator to know where to allocate an increment of storage so that the newly allocated space achieves the best possible performance, due to the complexity of the network, the complexity of analyzing workloads, and that physical storage attributes may be hidden from the application.

The problem of storage allocation has been done manually in most large storage environments. There is storage management software that will allocate or recommend where to allocate storage based on a number of algorithms. Nevertheless, these algorithms do not actually attempt to satisfy production performance requirements within the constraints of available storage.

It can be seen that there is a need for a method, apparatus and program storage device for providing automatic performance optimization of virtualized storage allocation within a network of storage elements.

### SUMMARY OF THE INVENTION

To overcome the limitations in the prior art described above, and to overcome other limitations that will become apparent upon reading and understanding the present specification, the present invention discloses a method, apparatus and program storage device for providing automatic performance optimization of virtualized storage allocation within a network of storage elements.

The present invention solves the above-described problems by providing storage to meet the desired performance requirements based on analysis of system parameters, workload requirements and/or other parameters.

An administration device in accordance to an embodiment of the present invention includes memory for storing data thereon and a processor configured for receiving from a user a request for storage of data, for obtaining workload requirements of the user making the request, for analyzing system parameters and for providing storage to meet the workload requirements based on the analysis of the system parameters.

In another embodiment of the present invention, a network storage system is provided. The network storage system includes a plurality of storage devices, a plurality of servers coupled to the plurality of storage devices via network interconnect and an administration device, coupled to at least the plurality of storage devices, for providing automatic performance optimization of virtualized storage allocation within a network of storage elements, wherein the administration device further includes memory for storing data thereon and a processor configured for receiving from a user a request for storage of data, for obtaining workload requirements of the user making the request, for analyzing system parameters and for providing storage to meet the workload requirements based on the analysis of the system parameters.

In another embodiment of the present invention, a method for providing automatic performance optimization of virtualized storage allocation within a network of storage elements is provided. The method includes receiving from a user a request for storage of data, Obtaining workload requirements of the user making the request, analyzing system parameters and providing storage to meet the workload requirements of the user based on the analysis of the system parameters.

In another embodiment of the present invention, a program storage device tangibly embodying one or more programs of instructions executable by the computer to perform a method for providing automatic performance optimization of virtualized storage allocation within a network of storage elements is provided. The method includes receiving from a user a request for storage of data, obtaining workload requirements of the user making the request, Analyzing system parameters and providing storage to meet the workload requirements of the user based on the analysis of the system parameters.

In another embodiment of the present invention, an administration device is provided. The administration device includes means for storing data thereon and means configured for receiving from a user a request for storage of data, obtaining workload requirements of the user making the request, analyzing system parameters and providing storage to meet the workload requirements of the user based on the analysis of the system parameters.

In another embodiment of the present invention, a network storage system is provided. The network storage system includes first means for providing storage, means for providing access to the means for providing storage and means, coupled to at least the plurality of storage devices, for providing automatic performance optimization of virtualized storage allocation within a network of storage elements, wherein the administration device further includes second means for storing data thereon and means for receiving from a user a request for storage of data, obtaining workload requirements of the user making the request, analyzing system parameters and providing storage to meet the workload requirements of the user based on the analysis of the system parameters.

In another embodiment of the present invention, a data structure resident in memory for providing automatic performance optimization of virtualized storage allocation within a network of storage elements is provided. The data structure includes at least one of a plurality of system attributes associated with determinations concerning desired system performance and a plurality of mechanisms for obtaining workload requirements.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 illustrates a computer network 100 in the form of a local area network;

FIG. 2 shows one embodiment of a SAN according to an embodiment of the present invention;

FIG. 3 illustrates a table of attributes incorporated into the storage virtualization optimizer according to an embodiment of the present invention;

FIG. 4 illustrates mechanisms of the storage virtualization optimizer for obtaining workload requirements according to an embodiment of the present invention;

FIG. 5 illustrates a data structure used by the storage virtualization optimizer to abstract the important performance elements in a storage network according to an embodiment of the present invention;

FIG. 6 illustrates a flow chart of the method for providing automatic performance optimization of virtualized storage allocation within a network of storage elements according to an embodiment of the present invention; and

FIG. 7 illustrates a flow chart of the determination of system parameters according to an embodiment of the present invention.

### DETAILED DESCRIPTION OF THE INVENTION

In the following description of the embodiments, reference is made to the accompanying drawings that form a part hereof, and in which is shown by way of illustration the specific embodiments in which the invention may be practiced. It is to be understood that other embodiments may be utilized because structural changes may be made without departing from the scope of the present invention.

The present invention provides a method, apparatus and program storage device for providing automatic performance optimization of virtualized storage allocation within a network of storage elements

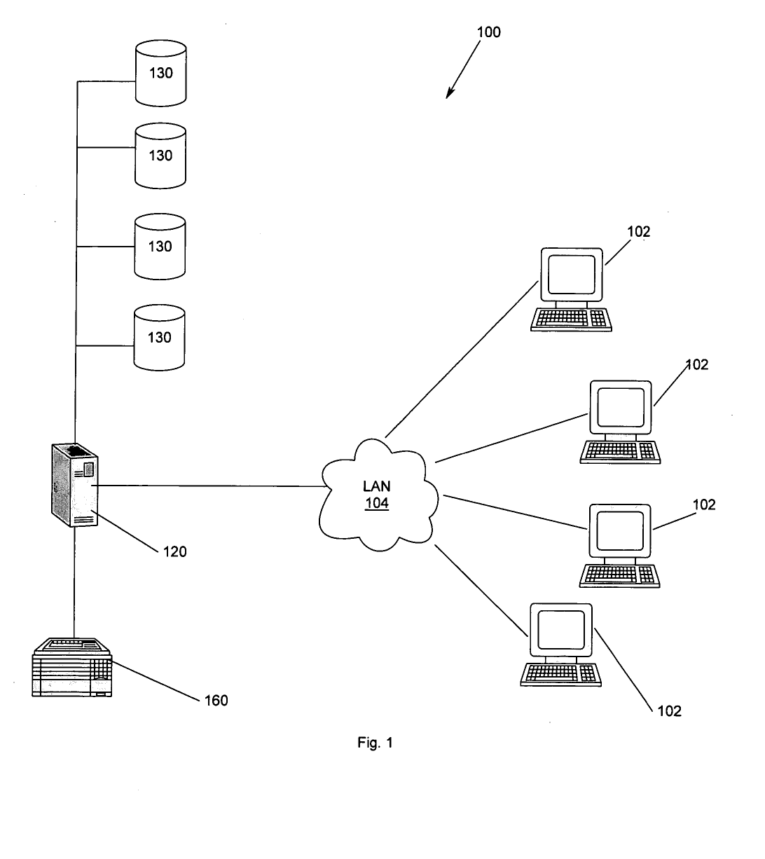

FIG. 1 illustrates a computer network 100 in the form of a local area network (LAN). In FIG. 1, workstation nodes 102 are coupled to a server 120 via a LAN interconnection 104. Data storage 130 is coupled to the server 120 via data bus 150. LAN interconnection 100 may be any number of network topologies, such as Ethernet.

The network shown in FIG. 1 is known as a client-server model of network. Clients are devices connected to the network that share services or other resources. A server 120 administers these services or resources. A server 120 is a computer or software program, which provides services to clients 102. Services that may be administered by a server include access to data storage 130, applications provided by the server 120 or other connected nodes (not shown), or printer sharing 160.

In FIG. 1, workstations 102 are clients of server 120 and share access to data storage 130 that is administered by server 120. When one of workstations 102 requires access to data storage 130, the workstation 102 submits a request to server 120 via LAN interconnect 100. Server 120 services requests for access from workstations 102 to data storage 130. One possible interconnect technology between server and storage is the traditional SCSI interface.

As networks such as shown in FIG. 1 grow, new clients 102 may be added, more storage 130 may be added and servicing demands may increase. As mentioned above, server 120 will service all requests for access to storage 130. Consequently, the workload on server 120 may increase dramatically and performance may decline. To help reduce the bandwidth limitations of the traditional client server model, Storage Area Networks (SAN) have become increasingly popular in recent years. Storage Area Networks interconnect servers and storage at high speeds. By combining existing networking models, such as LANs, with Storage Area Networks, performance of the overall computer network may be improved.

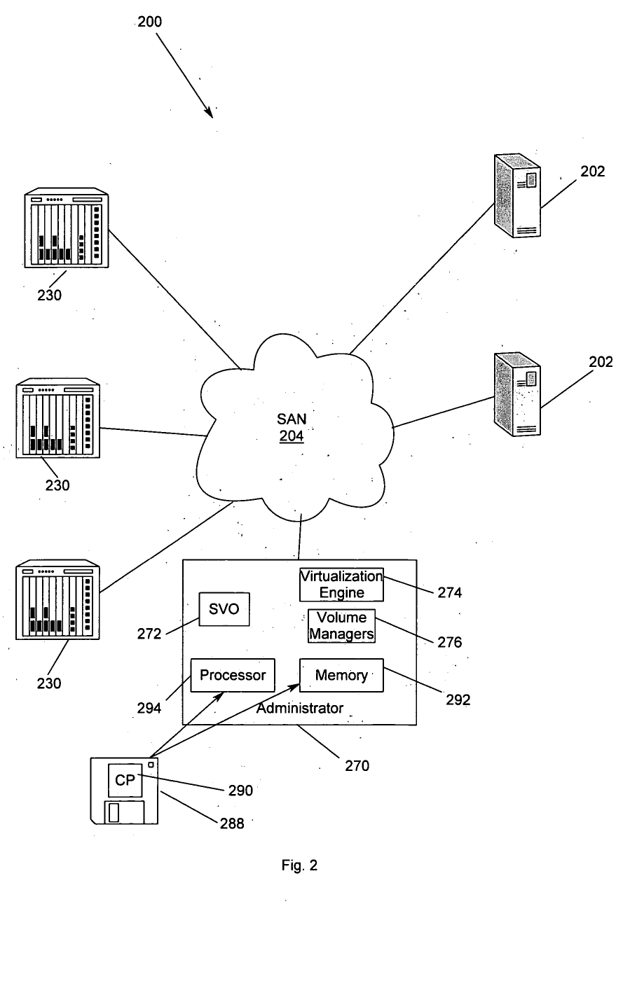

FIG. 2 shows one embodiment of a SAN 200 according to an embodiment of the present invention. In FIG. 2, servers 202 are coupled to data storage devices 230 via SAN interconnect 204. Each server 202 and each storage device 230 is coupled to SAN interconnect 200. Servers 202 have direct access to any of the storage devices 230 connected to the SAN interconnect. SAN interconnect 200 can be a high speed interconnect, such as Fibre Channel or small computer systems interface (SCSI). As FIG. 2 shows, the servers 202 and storage devices 230 comprise a network in and of themselves.

In the SAN 200 of FIG. 2, no server 202 is dedicated to a particular storage device 230 as in a LAN. Any server 202 may access any storage device 230 on the SAN 200 in FIG. 2. Typical characteristics of a SAN 200 may include high bandwidth, a multitude of nodes per loop, a large connection distance, and a very large storage capacity. Consequently, the performance, flexibility, and scalability of a Fibre Channel based SAN 200 may be significantly greater than that of a typical SCSI based system.

FIG. 2 also shows a network administrator 270 coupled to the SAN interconnect 204. Being able to effectively allocate storage 230 in a SAN 200 in a manner that provides for adequate data protection and recoverability is of particular importance. Because multiple hosts may have access to a particular storage array 230 in a SAN 200, prevention of unauthorized and/or untimely data access is desirable. Zoning is an example of one technique that is used to accomplish this goal. Zoning allows resources to be partitioned and managed in a controlled manner. The administrator 270 may be used to map hosts to storage and provide control to allocation of the storage devices 230.

The administrator 270 may be configured to aid in the selection of storage locations within a large network of storage elements. The administrator 270 includes a storage virtualization optimizer 272 that, according to an embodiment of the present invention, processes input/output in accordance with a customer's specified performance and space requirements, given a level of desired performance, attributes of the user's workload, the varying performance attributes of storage and its response to different types of workloads, and the presence of competing workloads within the network.

The storage virtualization optimizer 272 satisfies requests for storage within the network of storage elements in such a way as to meet the performance requirements specified with the request, or through a storage policy mechanism. The storage virtualization optimizer 272 monitors the user workload attributes and desired levels of performance, retains the latest information about the available capacity within the network of storage elements, monitors the performance characteristics of the individual pieces of storage at different locations within the network as a function of the user workload, and recognizes the presence and attributes of competing workloads sharing the use of storage over extended periods of time. Further, the storage virtualization optimizer 272 works not only in z/OS™, which is a highly secure, scalable, high-performance enterprise operating system that powers IBM's zSeries® processors, but also in heterogeneous Open System Environments, including Systems such as UNIX, AIX, LINUX, Windows, and similar OS or Volume. Manager Software Environments that support striped or composite storage volumes.

The storage virtualization optimizer 272 extends the policy based aspects to Open, System Environments and automates the selection of storage elements within the network to meet performance requirements by optimal usage of striped or composite volumes supported by the OS or Volume Manager software, or applications (such as database applications) which support the concept of striped volumes, such as DB2 and other database products. The storage virtualization optimizer 272 also extends the notions of allocating storage taking into consideration long-term data usage patterns. The storage virtualization optimizer 272 incorporates various attributes required to make intelligent choice of data placement.

A virtualization engine 274 and volume manager 276 may be used to stripe data within a virtual disk across managed disks. The virtualization optimizer 272 may make determinations of which nodes, i.e., engines such as the virtualization engine 274, may access the data, and which managed disk groups (groups of disks) would compose the LUNs to be selected. An additional important application of this would be to use the virtualization optimizer 272 to determine how to relocate, e.g., nodes or managed disk groups, the LUNs, i.e., virtual disks, to meet the customer's desired level of performance. The administrator may perform a calibration process 278 to discover the performance capabilities of the underlying disks. This would entail running specific tests to discover the performance parameters of those groups of disks.

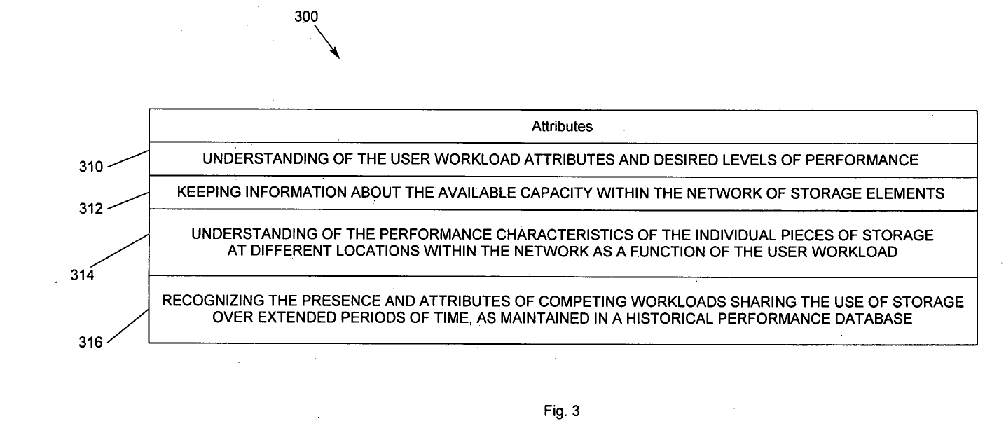

FIG. 3 illustrates a table 300 of attributes incorporated into the storage virtualization optimizer according to an embodiment of the present invention. These include understanding of the user workload attributes and desired levels of performance 310, keeping information about the available capacity within the network of storage elements 312, understanding of the performance characteristics of the individual pieces of storage at different locations within the network as a function of the user workload 314, and recognizing the presence and attributes of competing workloads sharing the use of storage over extended periods of time, as maintained in a historical performance database 316.

It is almost impossible to make intelligent data placement decisions without having a rudimentary understanding of the application workload requirements, or at least making reasonable assumptions about those workloads. For example, if a user asks for 100 GB of storage, a light performance requirement might allow allocating a single 100 GB logical disk, whereas a high performance application might require allocating ten 10 GB logical disks across 10 disk arrays, and striping of data across those arrays. Unfortunately, when most customers are asked what their workloads look like, they usually have no idea.

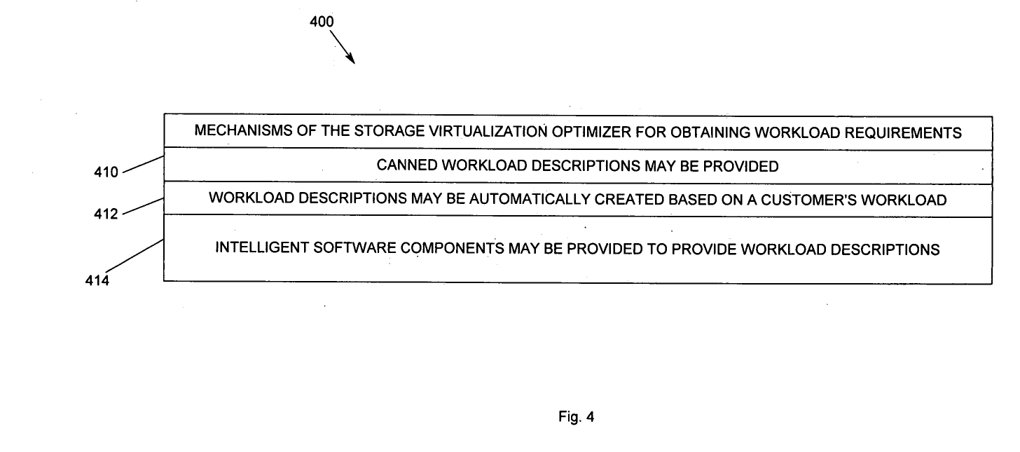

FIG. 4 illustrates mechanisms 400 of the storage virtualization optimizer for obtaining workload requirements according to an embodiment of the present invention. First, canned workload descriptions may be provided 410. Referring to FIG. 2, the storage virtualization optimizer 272 may provide canned workload descriptions in memory 292. The canned workload descriptions 410 may be based on characterizations of customer environments across various industries and applications. As examples, a set of named canned workloads, e.g., SAP_OLTP, DB2 Business Intelligence, etc., may be provided. With some advice from an application specialist, the customer initially selects one of these canned workloads 410.

Workload descriptions may also be automatically created based on observations of a customer's workload 412. Since every customer's workload has unique attributes, better workload assumptions can be obtained by observing storage access patterns in the customer's environment. Referring to FIG. 2, the storage virtualization optimizer 272 may base many of its decisions on observed disk access behavior, which it maintains in memory 292 in the form of a database. The storage virtualization optimizer 272 allows a user to point to a grouping of volumes and a particular window of time, and then create a workload description based on the observed behavior of those volumes. In this way, the storage virtualization optimizer 272 learns about a customer's workload, and enhances its decision-making over time.

Workload descriptions may also be provided by intelligent software components. 414. Referring to FIG. 2, the storage virtualization optimizer 272 may also include intelligent software components to provide workload descriptions. These workload descriptions may be based on special knowledge inherent in an application.

The workload parameters used by the storage virtualization optimizer 272 are selected based on their ability to accurately predict disk storage performance, and based on their general availability though data collection tools. The workload parameters used include the following: random read rate, sequential read rate, average read transfer size, random write rate, sequential write rate, average write transfer size, read cacheability indicator such as indicating cache hit ratio for a nominal ratio of storage capacity to read cache size, write cacheability indicator such as indicating cache destage percentage for a nominal ratio of storage capacity to write cache size, and time period over which the workload is most active (days of week, days of month, hours of day). The read and write rates above will be normalized, meaning that they are indicated “per gigabyte” of storage. In that way, the workload descriptions can be used to manage varying sizes of storage allocation requests.

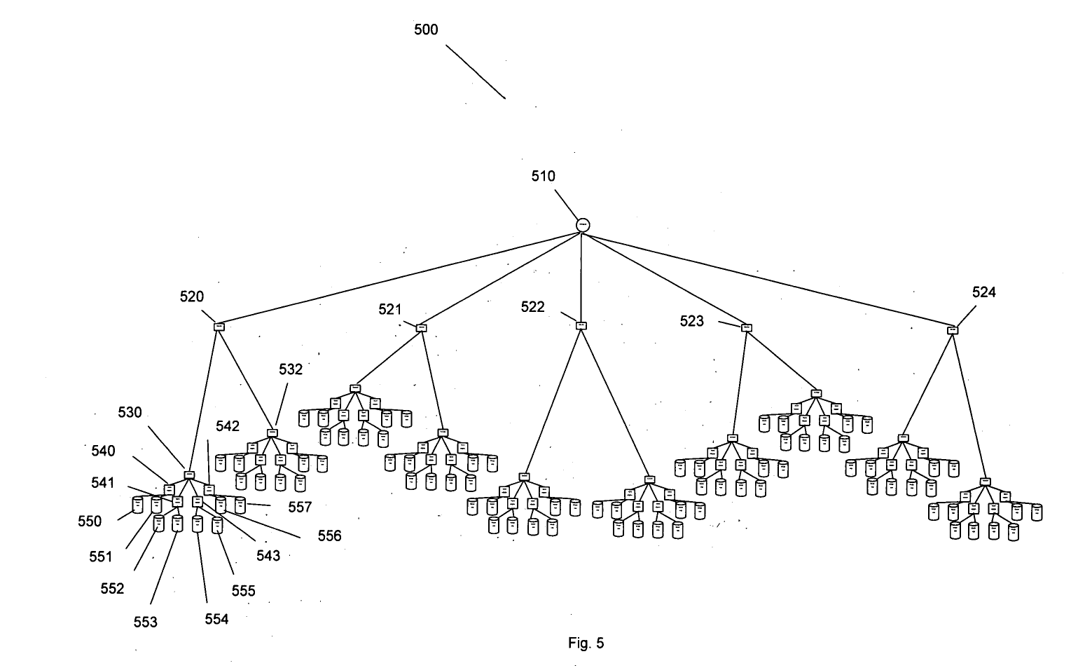

FIG. 5 illustrates a data structure 500 used by the storage virtualization optimizer to abstract the important performance elements in a storage network according to an embodiment of the present invention. The data structure may be a tree of nodes representing storage elements such as boxes, clusters, device adapters, and individual disks or disk arrays. However, those skilled in the art will recognize that the present invention is not meant to be limited to the structure shown in FIG. 5. Rather, a more general network of nodes than a tree structure may be used.

The tree structure at the root node represents a room full of independent storage boxes. The branches from the root to the first level of nodes represent the individual boxes or elements to be managed. From each of the first level nodes are one or more branches representing (but abstracting) some performance characteristic of the elements (boxes) under management.

For example, many storage boxes are built of clusters of two (or more) control elements. These clusters often have multiple device adapters, and the device adapters attach individual disks or arrays of disks. For example, with reference to the IBM ESS 510, from the root node there may emanate 5 branches to the first level representing five separate ESS boxes 520-524. From each first level node emanates two branches to two nodes at the second level representing the two controller clusters 530, 532 within the ESS. From each second level node (cluster) emanates four branches to nodes representing the four device adapters 540-543 in the cluster. From the third level nodes (device adapters) emanate multiple branches to nodes representing the storage arrays 550-557 attached to the adapters 540-543.

The exact number of levels and branches is not particularly important. Rather each node at each level represents an element of the storage configuration to which two kinds of numbers may be attached. First, a storage or space capacity may be attached. In addition, a performance capacity may be attached. These capacities may be structures with multiple metrics.

At each node, the performance capacity is specified as a function of the characteristics of the specified workloads. For example, the performance capacity may contain elements for random and sequential performance, high versus low cache hit ratios, or read versus write performance. The storage virtualization optimizer manipulates the available storage capacity and performance capacity structures at each level to make a recommendation for storage allocation that meets the capacity and the performance requirements specified overtly or through storage policy. In another embodiment of the present invention, neural networks may be provided and trained to make the balancing and optimizing choices described in this more deterministic algorithm.

Referring again to FIG. 2, the storage virtualization optimizer 272 improves with knowledge about how the storage elements are actually performing, but does not depend on extremely accurate information, which is why the storage virtualization optimizer 272 can work for heterogeneous types of storage from different vendors. But accurate real-time or historical performance data can be used to differentiate one vendor's products from others, as well as biasing storage allocations away from workloads that are likely to compete during the time periods of interest.

An important aspect of the storage virtualization optimizer 272 involves the use of the capacity and performance structures to balance storage allocation across available resources. Where multiple choices are possible in the storage virtualization optimizer 272, the capacity and performance structures may be used to bias allocation to one set of resources through the use of pseudo-random numbers. Several sample allocations can be selected in this fashion, and the best among the samples chosen for the answer. With a deterministic algorithm there is a certain stochastic element in the final allocation. In this way, storage allocations will be biased toward elements in the network that are most capable of handling the specified workload.

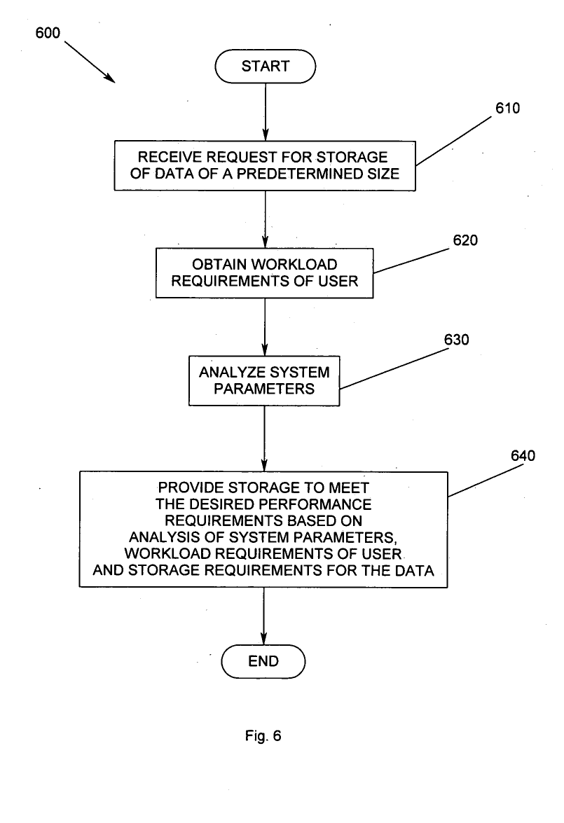

FIG. 6 illustrates a flow chart 600 of the method for providing automatic performance optimization of virtualized storage allocation within a network of storage elements according to an embodiment of the present invention. A request for storage of data of a predetermined size is received 610. The storage virtualization optimizer obtains workload requirements of the user 620. The storage virtualization optimizer analyzes system parameters 630. Then, the storage virtualization optimizer provides storage to meet the desired performance requirements based on analysis of system parameters, workload requirements of user and storage requirements for the data 640. The storage virtualization optimizer selects the storage locations within a large network of storage elements that meet a customer's specified performance and space requirements. The customer's specified performance and space requirements are specified with the request, or through a storage policy mechanism.

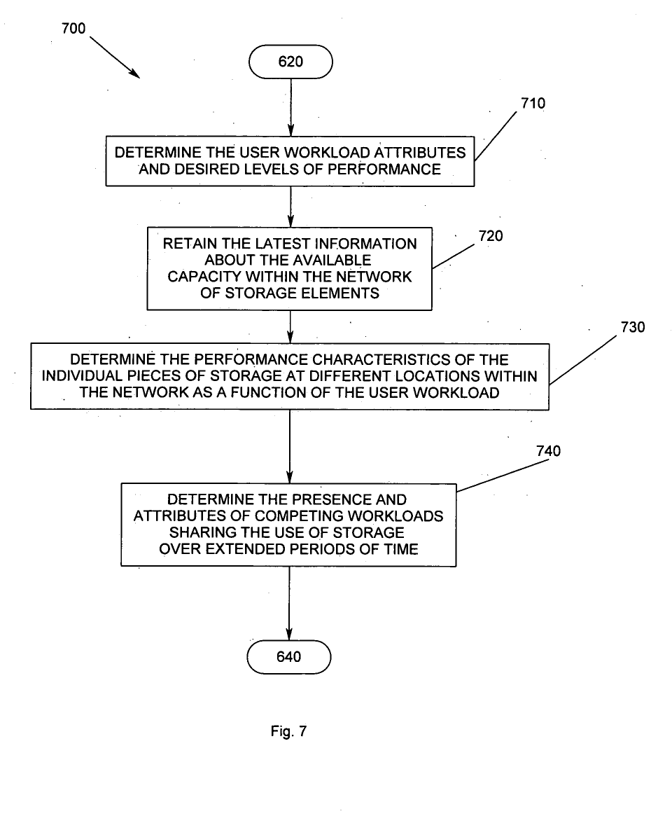

FIG. 7 illustrates a flow chart 700 of the determination of system parameters according to an embodiment of the present invention. The storage virtualization optimizer analyzes system parameters by determining the user workload attributes and desired levels of performance 710. The storage virtualization optimizer retains the latest information about the available capacity within the network of storage elements 720. The storage virtualization optimizer determines the performance characteristics of the individual pieces of storage at different locations within the network as a function of the user workload 730. The storage virtualization optimizer analyzes system parameters determines the presence and attributes of competing workloads sharing the use of storage over extended periods of time 740. The storage virtualization optimizer then provides storage to meet the desired performance requirements based on analysis as described above with reference to FIG. 6.

The process illustrated with reference to FIGS. 2-7 may be tangibly embodied in a computer-readable medium or carrier, e.g. one or more of the fixed and/or removable data storage devices 288 illustrated in FIG. 2, or other data storage or data communications devices. The computer program 290 may be loaded into memory 292 to configure the administrator 270 or storage virtualization optimizer, 272 for execution. The computer program 290 include instructions which, when read and executed by a processor, such as processors 294 of FIG. 2, causes the administrator 270 or storage virtualization optimizer 272 to perform the steps necessary to execute the steps or elements of the present invention.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

1. An administration device for providing automatic performance optimization of virtualized storage allocation within a network of storage elements, comprising:
memory for storing data thereon; and
a processor configured for receiving from a user a request for storage of data, for obtaining workload requirements of the user making the request, for analyzing system parameters and for providing storage to meet the workload requirements based on the analysis of the system parameters.

2. The administration device of claim 1, wherein the processor provides storage to meet the workload requirements based on the workload requirements of the user and storage requirements for the data.

3. The administration device of claim 1, wherein the processor provides storage to meet the workload requirements by selecting storage locations that meet performance and space requirements of the request.

4. The administration device of claim 3, wherein the processor selects storage locations that meet the performance and space requirements through analysis of the request for storage.

5. The administration device of claim 3, wherein the processor selects storage locations that meet the performance and space requirements through a storage policy mechanism.

6. The administration device of claim 1, wherein the processor determines workload attributes of the user and desired levels of performance, retains the latest information about the available capacity within the network of storage elements, determines performance characteristics of individual storage devices at different locations within the network as a function of the workload requirements of the user, and determines a presence and attributes of competing workloads sharing the storage devices over extended periods of time.

7. The administration device of claim 1, wherein the processor is configured for obtaining workload requirements of the, user by using canned workload descriptions that are based on characterizations of user environments across various industries and applications.

8. The administration device of claim 1, wherein the processor is configured for obtaining workload requirements of the user by automatically creating workload requirements based on observations of storage access patterns of a user.

9. The administration device of claim 1, wherein the processor is configured for obtaining workload requirements of the user by using intelligent software components that analyze workload descriptions for an application of the user.

10. The administration device of claim 1, wherein the processor is configured for accessing a virtualization engine and volume managers to stripe data within a virtual disk across managed storage devices.

11. The administration device of claim 1, wherein the processor is configured for determining how to relocate virtual disks to meet a desired level of performance.

12. The administration device of claim 1, wherein the processor is configured for performing a calibration process to discover the performance capabilities of the underlying storage devices.

13. A network storage system, comprising:
a plurality of storage devices;
a plurality of servers coupled to the plurality-of storage, devices via network interconnect; and
an administration device, coupled to at least the plurality of storage devices, for providing automatic performance optimization of virtualized storage allocation within a network of storage elements, wherein the administration device further comprises:
memory for storing data thereon; and
a processor configured for receiving from a user a request for storage of data, for obtaining workload requirements of the user making the request, for analyzing system parameters and for providing storage to meet the workload requirements based on the analysis of the system parameters.

14. The network storage system of claim 13, wherein the processor provides storage to meet the workload requirements based on the workload requirements of the user and storage requirements for the data.

15. The network storage system of claim 13, wherein the processor provides storage to meet the workload requirements by selecting storage locations that meet performance and space requirements of the request.

16. The network storage system of claim 15, wherein the processor selects storage locations that meet the performance and space requirements through analysis of the request for storage.

17. The network storage system of claim 15, wherein the processor selects storage locations that meet the performance and space requirements through a storage policy mechanism.

18. The network storage system of claim 13, wherein the processor determines workload attributes of the user and desired levels of performance, retains the latest information about the available capacity within the network of storage elements, determines performance characteristics of individual storage devices at different locations within the network as a function of the workload requirements of the user, and determines a presence and attributes of competing workloads sharing the storage devices over extended periods of time.

19. The network storage system of claim 13, wherein the processor is configured for obtaining workload requirements of the user by using canned workload descriptions that are based on characterizations of user environments across various industries and applications.

20. The network storage system of claim 13, wherein the processor is configured for obtaining workload requirements of the user by automatically creating workload requirements based on observations of storage access patterns of a user.

21. The network storage system of claim 13, wherein the processor is configured for obtaining workload requirements of the user by using intelligent software components that analyze workload-descriptions for an application of the user.

22. The network storage system of claim 13, wherein the processor is configured for accessing a virtualization engine and volume managers to stripe data within a virtual disk across managed storage devices.

23. The network storage system of claim 13, wherein the processor is configured for determining how to relocate virtual disks to meet a desired level of performance.

24. The network storage system of claim 13, wherein the processor is configured for performing a calibration process to discover the performance capabilities of the underlying storage devices.

25. A method for providing automatic performance optimization of virtualized storage allocation within a network of storage elements, comprising:
receiving from a user a request for storage of data;
obtaining workload requirements of the user making the request;
analyzing system parameters; and
providing storage to meet the workload requirements of the user based on the analysis of the system parameters.

26. The method of claim 25, wherein the providing storage to meet the workload requirements of the user is further based on the workload requirements of the user and storage requirements for the data.

27. The method of claim 25, wherein the providing storage to meet the workload requirements of the user further comprises selecting storage locations that meet performance and space requirements of the request.

28. The method of claim 27, wherein the selecting storage locations that meet the performance and space requirements are provided with the request for storage.

29. The method of claim 27, wherein the selecting storage locations that meet the performance and space requirements are provided through a storage policy mechanism.

30. The method of claim 25, wherein the analyzing system parameters further comprises determining the workload attributes of the user and desired levels of performance, retaining the latest information about the available capacity within the network of storage elements, determining performance characteristics of the storage devices at different locations within the network as a function of the workload requirements of the user, and determining a presence and attributes of competing workloads sharing the storage devices over extended periods of time.

31. The method of claim 25, wherein the obtaining workload requirements of the user making the request further comprises using canned workload descriptions that are based on characterizations of user environments across various industries and applications.

32. The method of claim 25, wherein the obtaining workload requirements of the user making the request further comprises automatically creating workload requirements based on observations of storage access patterns of a user.

33. The method of claim 25, wherein the obtaining workload requirements of the user making the request further comprises using intelligent software components that analyze workload descriptions for an application of the user.

34. The method of claim 25 further comprising accessing a virtualization engine and volume managers to stripe data within a virtual disk across managed storage devices.

35. The method of claim 34, wherein the striping data further comprises determining how to relocate virtual disks to meet a desired level of performance.

36. The method of claim 25, further comprising performing a calibration process to discover the performance capabilities of the underlying storage devices.

37. A program storage device readable by a computer, the program storage device tangibly embodying one or more programs of instructions executable by the computer to perform a method for providing automatic performance optimization of virtualized storage allocation within a network of storage elements, the method comprising:
receiving from a user a request for storage of data;
obtaining workload requirements of the user making the request;
analyzing system parameters; and
providing storage to meet the workload requirements of the user based on the analysis of the system parameters.

38. The program storage device of claim 19, wherein the analyzing system parameters further comprises determining workload attributes of the user and desired levels of performance, retaining the latest information about the available capacity within the network of storage elements, determining performance characteristics of storage devices at different locations within the network as a function of the workload requirements of the user, and determining a presence and attributes of competing workloads sharing the storage devices over extended periods of time.

39. An administration device for providing automatic performance optimization of virtualized storage allocation within a network of storage elements, comprising:
means for storing data thereon; and
means configured for receiving from a user a request for storage of data, obtaining workload requirements of the user making the request, analyzing system parameters and providing storage to meet the workload requirements of the user based on the analysis of the system parameters.

40. A network storage system, comprising:
first means for providing storage;
means for providing access to the means for providing storage; and
means, coupled to at least the plurality of storage devices, for providing automatic performance optimization of virtualized storage allocation within a network of storage elements, wherein the administration device further comprises:
second means for storing data thereon; and
means for receiving from a user a request for storage of data, obtaining workload requirements of the user making the request, analyzing system parameters and providing storage to meet the workload requirements of the user based on the analysis of the system parameters.

41. A data structure resident in memory for providing automatic performance optimization of virtualized storage allocation within a network of storage elements, comprising at least one of a plurality of system attributes associated with determinations concerning desired system performance and a plurality of mechanisms for obtaining workload requirements.

42. The data structure of claim 41, wherein the plurality of system attributes includes understanding of the user workload attributes and desired levels of performance, keeping information about the available capacity within the network of storage elements, understanding of the performance characteristics of the individual pieces of storage at different locations within the network as a function of the user workload, and recognizing the presence and attributes of competing workloads sharing the use of storage over extended periods of time, as maintained in a historical performance database.

43. The data structure of claim 41, wherein the plurality of mechanisms for obtaining workload requirements include canned workload descriptions; automatically created workload descriptions based on observations of a customer's workload and workload descriptions provided by intelligent software components.
